(19) United States
(12) Patent Application Publication
(10) Pub. No.: US 2002/0196540 A1
(43) Pub. Date: Dec. 26, 2002

(54) Interleaver having Gires-Tournois resonator

(76) Inventor: Bin Zhao, Irvine, CA (US)

Correspondence Address: STRADLING YOCCA CARLSON & RAUTH, IP Department, P.O. Box 7680, 660 Newport Center Drive, Suite 1600, Newport Beach, CA, 92660-6441, US

(21) Appl. No.: 10/002,096

(22) Filed: Oct. 18, 2001

Related U.S. Application Data
(60) Provisional application No. 60/244,624, filed on Oct. 31, 2000.

(51) Int. Cl. G02B 5/30

(52) U.S. Cl. 359/495

(57) ABSTRACT

An interleaver has a beam separator/recombiner configured to separate at least one component beam into first and second approximately equal amplitude components thereof. Each component beam has a defined polarization direction. The beam separator/recombinder is also configured so as to subsequently recombine the separated first and second subcomponents back into components. A first reflector or GT resonator is configured so as to direct the first subcomponent from the beam separator/recombinder back into the beam separator/recombiner. A second reflector or GT resonator is configured so as to direct the second subcomponent from the beam separator/recombiner back into the beam separator/recombiner.

### CROSS-REFERENCE TO RELATED APPLICATIONS

This patent application claims the benefit of the filing date of United States Provisional Patent Application Serial No. 60/244,624, filed on Oct. 31, 2000 and entitled INTERLEAVER FOR OPTICAL COMMUNICATIONS, the entire contents of which are hereby expressly incorporated by reference.

### FIELD OF THE INVENTION

The present invention relates generally to optical devices and relates more particularly to a comb filter and interleaver for optical communications and the like.

### BACKGROUND OF THE INVENTION

According to wavelength-division multiplexing (WDM) and dense wavelength-division multiplexing (DWDM), a plurality of different wavelengths of light are transmitted via a single medium such as an optical fiber. Each wavelength corresponds to a separate channel and carries information generally independently with respect to the other channels. The plurality of wavelengths (and consequently the corresponding plurality of channels) are transmitted simultaneously without interference with one another, so as to substantially enhance the transmission capability of the communication system. Thus, a much greater amount of information can be transmitted than is possible utilizing a single wavelength optical communication system.

The individual channels of a wavelength-division multiplexed or dense wavelength-division multiplexed signal must be selected or separated from one another at the receiver side in order to facilitate detection and demodulation thereof. This separation or demultiplexing process can be performed or assisted by a comb filter or an interleaver. A similar device facilitates multiplexing of the individual channels at the transmitter side.

Modem dense wavelength-division multiplexed (DWDM) optical communications and the like require that network systems offer an ever-increasing number of channel counts, thus mandating the use of a narrower channel spacing in order to accommodate the increasing number of channel counts. The optical interleaver, which multiplexes and demultiplexes optical channels with respect to the physical media, i.e., optical fiber, offers a potential upgrade path, so as to facilitate scalability in both channel spacing and number of channel counts in a manner which enhances the performance of optical communication networks.

As a multiplexer, an interleaver can combine two streams of optical signals, wherein one stream contains odd channels and the other stream contains even channels, into a single, more densely spaced optical signal stream. As a demultiplexer, an interleaver can separate a dense signal stream into two, wider spaced streams, wherein one stream contains the odd channels and the other stream contains the even channels. Thus, the interleaver offers scalability which allows contemporary communication technologies that perform well at wider channel spacing to address narrower, more bandwidth efficient, channel spacings.

It is important that the interleaver separate the individual channels sufficiently so as to mitigate undesirable crosstalk therebetween. Crosstalk occurs when channels overlap, i.e., remain substantially unseparated, such that some portion of one or more non-selected channels remains in combination with a selected channel. As those skilled in the art will appreciate, such crosstalk interferes with the detection and/or demodulation process. Generally, the effects of crosstalk must be compensated for by undesirably increasing channel spacing and/or reducing the communication speed, so as to facilitate reliable detection/demodulation of the signal.

However, as channel usage inherently increases over time, the need for efficient utilization of available bandwidth becomes more important. Therefore, it is highly undesirable to increase channel spacing and/or to reduce communication speed in order to compensate for the effects of crosstalk. Moreover, it is generally desirable to decrease channel spacing and to increase communication speed so as to facilitate the communication of a greater quantity of information utilizing a given bandwidth.

Since it is generally impractical and undesirably expensive to provide precise control during manufacturing, the actual wavelength of communication channels and the center wavelength of filters generally tend to mismatch with each other. Precise control of manufacturing processes is difficult because it involves the use of more stringent tolerances which inherently require more accurate manufacturing equipment and more time consuming procedures. The actual wavelength of the communication channel and the center wavelength of the filter also tend to drift over time due to inevitable material and device degradation over time and also due to changes in the optical characteristics of optical components due to temperature changes. Therefore, it is important that the passband be wide enough so as to include a selected signal, even when both the carrier wavelength of the selected signal and the center wavelength of the filter passband are not precisely matched or aligned during manufacturing and have drifted substantially over time.

Although having a wider filter passband is generally desirable, so as to facilitate the filtering of signals which have drifted somewhat from their nominal center wavelength, the use of such wider passbands and the consequent accommodation of channel center wavelength drift does introduce the possibility for undesirably large dispersion being introduced into a filtered channel. Typically, the dispersion introduced by a filter or interleaver increases rapidly as the channel spacing is reduced and as a channel moves away from its nominal center wavelength, as discussed in detail below. Thus, as more channel wavelength error is tolerated in a filter or interleaver, greater dispersion valves are likely to be introduced.

As those skilled in the art will appreciate, dispersion is the non-linear phase response of an optical device or system wherein light of different wavelengths is spread or dispersed, such that the phase relationship among the different wavelengths varies undesirably as the light passes through the device or system. Such dispersion undesirably distorts optical signals, such as those used in optical communication systems.

Contemporary interleavers have dispersion versus wavelength curves which have zero dispersion value at a particular wavelength, such as at nominal channel center wavelength. The dispersion versus wavelength curve of such contemporary interleavers departs drastically from this zero dispersion value as the wavelength moves away from the nominal channel center wavelength. Thus, small deviations in channel wavelength from its nominal center wavelength can result in undesirably large dispersion values.

Since, as discussed in detail above, it is extremely difficult, if not impossible, to maintain the actual channel wavelength precisely at its nominal value, such channel center wavelengths do vary, thereby resulting in undesirably large dispersion values.

As channel spacing is decreased continuously for larger channel count over a given bandwidth, significant and undesirable dispersion appears and can dramatically degrade optical signal quality, particularly in high bit rate optical communication systems.

There are four basic types of interleavers suitable for multiplexing and demultiplexing optical signals. These include birefringent filters, thin-film dielectric devices, planar waveguides, and fiber-based devices. All of these contemporary interleaving technologies suffer from substantial limitations with respect to channel spacing, dispersion, insertion loss, channel isolation, temperature stability, cost, reliability and flexibility.

Thus, there is a need to provide an optical interleaver which can overcome or mitigate at least some of the above-mentioned limitations.

### SUMMARY OF THE INVENTION

The present invention specially addresses and alleviates the above-mentioned deficiencies associated with the prior art. More particularly, the present invention comprises an interleaver comprising a beam separator/recombiner configured to separate at least one component beam into first and second approximately equal magnitude subcomponents thereof. Each component beam has a defined polarization direction. The beam separator/recombiner is also configured to subsequently recombined the separated first and second subcomponents back into components. A first reflector or GT resonator is configured to direct the first subcomponent from the beam separator/recombiner back into the beam separator/recombiner. A second reflector or GT resonator is configured to direct the second subcomponent from the beam separator/recombiner back into the beam separator/recombiner.

Optionally, the present invention further comprises at least one dispersion mitigating stage, wherein each dispersion mitigating stage comprises a dispersion mitigating Gires-Tournois resonator and a polarization beam splitter configured to transmit light from the beam separator/recombiner to a dispersion mitigating Gires-Tournois resonator. The polarization beam splitter is further configured so as to reflect light from the dispersion mitigating Gires-Tournois resonator away from light input to the polarization beam splitter, such that the light reflected away from the light input to the polarization beam splitter does not interfere with the light input to the polarization beam splitter.

It is understood that changes in the specific structure shown and described may be made within the scope of the claims without departing from the spirit of the invention.

### BRIEF DESCRIPTION OF THE DRAWINGS

These, and other features, aspects and advantages of the present invention will be more fully understood when considered with respect to the following detailed description, appended claims and accompanying drawings, wherein:

FIG. 1 is a schematic diagram showing a top view of a single-stage interleaver comprising two Gires-Tournois resonators according to the present invention;

FIG. 2 is a schematic diagram showing the optical beam states and the orientations of half-wave waveplates and quarter-wave waveplates at different locations in the single-stage interleaver of FIG. 1;

FIG. 3 is a schematic diagram showing a top view of a two-stage interleaver, wherein each stage comprises a Gires-Tournois resonator according to the present invention;

FIG. 4 is a schematic diagram showing the optical beam states and the orientations of half-wave waveplates and quarter-wave waveplates at different locations in the two-stage interleaver of FIG. 3;

FIG. 5 is a schematic diagram showing a top view of a three-stage interleaver, wherein each stage comprises a Gires-Tournois resonator according to the present invention;

FIG. 6 is a schematic diagram showing the optical beam states and the orientations of half-wave waveplates and quarter-wave waveplates at different locations in the three-stage interleaver of FIG. 5;

FIG. 7 is a top view of a schematic diagram showing an alternative folded configuration of a two-stage interleaver, wherein a single polarizaton beam splitter defines two-stages and wherein each stage comprises a Gires-Tournois resonator according to the present invention;

FIG. 8 is a schematic diagram showing the optical beam states and the orientations of half-wave waveplates and quarter-wave waveplates at different locations in the two-stage interleaver of FIG. 7;

FIG. 9 is a top view of a schematic diagram showing an alternative configuration of a three-stage interleaver, wherein a single polarizaton beam splitter defines three-stage and wherein each stage comprises a Gires-Tournois resonator;

FIG. 10 is a schematic diagram showing the optical beam states and the orientations of half-wave waveplates and quarter-wave waveplates at different locations in the three-stage interleaver of FIG. 9;

FIG. 11 is a chart showing dispersion versus wavelength for one channel in a single-stage 50 GHz interleaver (such as that of FIG. 1), wherein r₁=0.38;

FIG. 12 is a chart showing transmission versus wavelength for one channel in a single-stage 50 GHz interleaver (such as that of FIG. 1), wherein r₁=0.38;

FIG. 13 is a chart showing dispersion versus wavelength for one channel in a two-stage 50 GHz interleaver (such as that of FIG. 3 or FIG. 7), wherein r₁=0.38, r₂=0.04 and Γ₂/Γ₁=1.0001285;

FIG. 14 is a chart showing transmission versus wavelength for one channel in a two-stage birefringent element 50 GHz interleaver (such as that of FIG. 3 or FIG. 7), wherein r₁=0.38, r₂=0.04 and Γ₂/Γ₁=1.0001285;

FIG. 15 is a chart showing dispersion versus wavelength for one channel in a two-stage 50 GHz interleaver (such as that of FIG. 3 or FIG. 7), wherein r₁=0.38, r₂=0.05 and Γ₂/Γ₁=1.0001285;

FIG. 16 is a chart showing transmission versus wavelength for one channel in a two-stage 50 GHz interleaver (such as that of FIG. 3 or FIG. 7), wherein r₁=0.38, r₂=0.05 and Γ₂/Γ₁=1.0001285;

FIG. 17 is a chart showing dispersion versus wavelength for one channel in a three-stage 50 GHz interleaver (such as that of FIG. 5 or FIG. 9), wherein r₁=0.38, r₂=0.09, r₃=0.09, and Γ₂/Γ₁=1.0001720 and Γ₃/Γ₁=1.0000853; and

FIG. 18 is a chart showing transmission versus wavelength for one channel in a three-stage 50 GHz interleaver (such as that of FIG. 5 or FIG. 9) wherein r₁=0.38, r₂=0.09, r₃=0.09, and Γ₂/Γ₁=1.0001720 and Γ₃/Γ₁=1.0000853.

### DETAILED DESCRIPTION OF THE INVENTION

The detailed description set forth below in connection with the appended drawings is intended as a description of the presently preferred embodiments of the invention and is not intended to represent the only forms in which the present invention may be constructed or utilized. The description sets forth the functions of the invention and the sequence of steps for constructing and operating the invention in connection with the illustrated embodiments. It is to be understood, however, that the same or equivalent functions and sequences may be accomplished by different embodiments that are also intended to be encompassed with the spirit and scope of the invention.

The description contained herein is directed primarily to the configuration of an interleaver as a demultiplexer. However, as those skilled in the art will appreciate, the present invention may be used in both demultiplexers and multiplexers. The difference between demultiplexers and multiplexers is small and the configuration of the present invention as either desired device is well within the ability of one of the ordinary skill in the art.

A reference system is used for the determination of the angular orientations of waveplates with respect to a moving (x, y, z) coordinate system. The angular orientations of waveplates are measured by the optic axes of waveplates with respect to the +x axis. However, it is very important to appreciate that the +x axis is part of the moving coordinate system. This coordinate system travels with the light, such that the light is always traveling in the +z direction and such that the +y axis is always up as shown in the drawings of device configuration. Thus, when the light changes direction, the coordinate system rotates with the +y axis thereof so as to provide a new coordinate system. The use of such a moving coordinate system allows the optical beam states, and the waveplates to be viewed in a consistent manner at various locations in the devices, i.e., always looking into the light, and therefore substantially simplifies viewing and analysis of the devices.

Determination of the angular orientations in (x, y, z) coordinate system is made by observing oncoming light with the convention that the angle is positive if the rotation of the corresponding optical axis is counter-clockwise with respect to +x axis and is negative if the rotation is clockwise with respect to the +x axis (which is consistent with the conventional use of (x, y, z) coordinate system.

The present invention comprises an interleaver comprising at least one asymmetric Fabry-Perot resonator (Gires-Tournois resonator). Further, the present invention comprises additional dispersion mitigating, asymmetric Fabry-Perot resonators (Gires-Tournois resonators) configured so as to mitigate dispersion. The asymmetric Fabry-Perot resonator may be configured so as to mitigate dispersion of the interleaver itself, of the interleaver in combination with any other component or components of an optical communication system or the like, or of any other component or components (but not including the interleaver itself) of an optical communications system or the like.

According to one aspect of the present invention, at least one stage, preferably multiple stages, of dispersion compensation are provided. Each stage of dispersion compensation comprises a polarization beam splitter and a Gires-Tournois resonator. Half-wave and quarter-wave waveplates are used as necessary, so as to cause the beams to travel through the polarization beam splitter in the desire direction and with the desire amplitude. Each stage of dispersion compensation mitigates undesirable dispersion, but does not substantially alter the transmission characteristics of the interleaver. That is, one portion of the device, i.e., the interleaver portion thereof which comprises a first beam splitter and a pair of Gires-Tournois resonators defines an interleaver which determines the transmission characteristics of the device and a separate portion thereof which comprises additional polarization beam splitters and Gires-Tournois resonators defines the dispersion mitigation characteristics of the device.

It is worthwhile to note that although polarization beam displacers and polarization beam splitters are shown and described as important components of the both the interleaver portion of the device and the dispersion mitigation portion of the device, the use of polarization beam displacers and polarization beam splitters is by way of example only, and not by way of limitation. Those skilled in the art will appreciate that other devices may similarly be utilized to effect separation of the beams of light into two generally orthogonal components thereof.

More particularly, the interleaver of the present invention comprises an input polarization separation element, an intermediate polarization separation element, an output polarization separation element, and a channel interleaving element assembly. An example for the polarization separation element is a polarization beam displacer.

The channel interleaving assembly comprises a polarization beam splitter and half-wave waveplates configured to separate light (such as from a polarization beam displacer) into two subcomponents thereof of approximately equal amplitude; a first reflector cooperating with the polarization beam splitter to define a first path along which the first subcomponent is transmitted; and a second reflector cooperating with the polarization beam splitter to define a second path along which the second subcomponent is transmitted.

The present invention comprises at least one Gires-Tournois resonator, preferably two Gires-Tournois resonators, in an interleaver portion thereof. The present invention can further comprises a Gires-Tournois resonator in each dispersion mitigating stage thereof. As many dispersion mitigating stages as desired may be utilized, so as to provide the desired dispersion characteristics.

As those skilled in the art will appreciate, the Gires-Tournois resonator is a type of Fabry-Perot resonator wherein a light transmissive material has a first, partially reflecting surface through which light enters and has a fully reflective rear surface thereof. Thus, a portion of light which is directed toward a Gires-Tournois resonator is reflected therefrom and consequently does not enter the Gires-Tournois resonator. Another portion of the light directed toward a Gires-Tournois resonator is reflected by the fully reflective rear surface thereof. A portion of the light reflected by the fully reflective rear surface of the Gires-Tournois resonator exits the Gires-Tournois resonator. Another portion of the light reflected by the fully reflective rear surface of the Gires-Tournois resonator is reflected by the partially reflective front surface thereof back to the rear surface. Each time light is reflected by the back surface, some portion thereof is reflected back to the rear surface. In this manner, multiple reflections cause interference of the light exiting the Gires-Tournois resonator such that some wavelengths of light are enhanced, (constructive interference) while other wavelengths thereof are mitigated (destructive interference).

Alternatively, a reflector, such as a prism or a pair of mirrors, is configured so as to direct light from the polarization beam splitter back through the polarization beam splitter such that the same polarization beam splitter is used for interleaver stage and dispersion mitigating stages. In this fold configuration, the intermediate polarization beam displacer is preferably disposed intermediate the prism and the polarization beam splitter.

Thus, according to the present invention, a method for channel interleaving comprises separating a composite beam of light into first and second generally orthogonally polarized components thereof. The first and second components are separated into two subcomponents each of approximately equal amplitude. One subcomponent of each component is caused to be transmitted through a Gires-Tournois reflector before being recombined with the other subcomponent thereof. In this manner, channel interleaving is performed. Optionally, one or more stages of dispersion mitigation follow channel interleaving. In each stage of dispersion mitigation, light is transmitted through a polarization beam splitter, a quarter-wave waveplate, and a Gires-Tournois resonator.

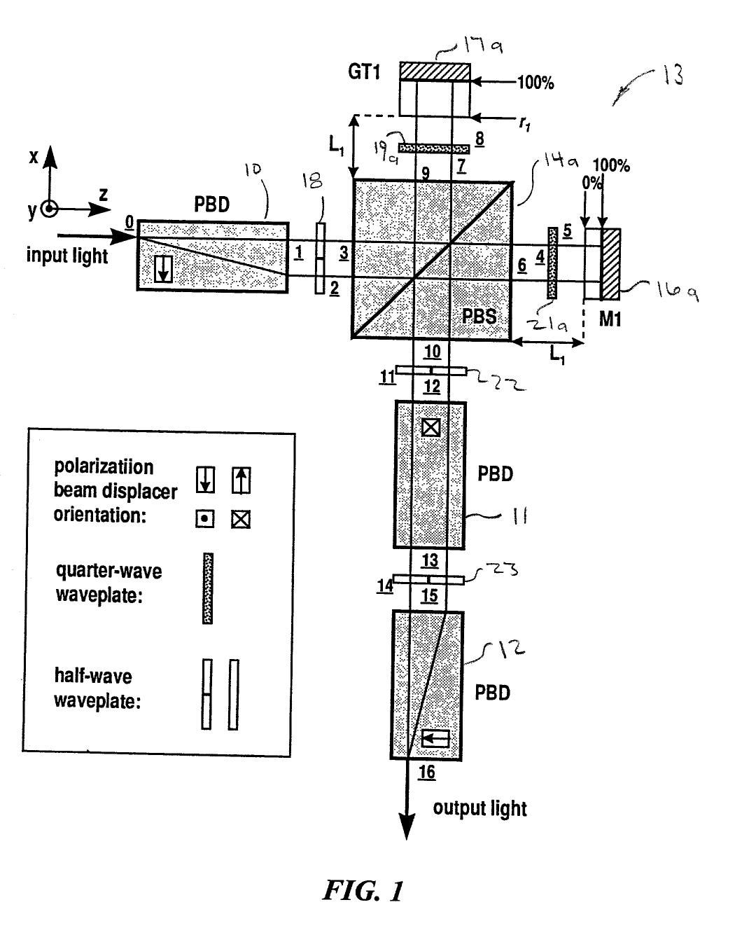

Referring now to FIG. 1, a single-stage interleaver is shown. The single-stage interleaver manipulates the input optical light so as to achieve the desired channel interleaving performance.

As discussed in detail above, a right-hand coordinate system of axes is used to characterize the optical beam propagation and the system at various locations with a convention that the light is always propagating in the +z direction and the +y direction is always out of the plane of the paper in FIG. 1.

As shown in FIG. 1, a polarization beam displacer 10 provides light to half-wave waveplates 18 from which the light is transmitted to polarization beam splitter 14a. The polarization beam splitter 14a splits the light such that it travels both to Gires-Tournois (GT) resonators 16a and 17a, respectively. GT resonator 16a has zero reflection at the first interface thereof.

Light transmitted from the polarization beam splitter 14a to the GT resonator 16a passes through quarter-wave waveplate 21a. Similarly, light transmitted from the polarization beam splitter 14a to the GT resonator 17a passes through quarter-wave waveplate 19a. Light from the GT resonator 16a and GT resonator 17a is recombined by the polarization beam splitter 14a and passes through half-wave waveplates 22. Light from the half-wave waveplates 22 passes through intermediate polarization beam displacer 11 and is then transmitted through half-wave waveplates 23 to output polarization beam displacer 12.

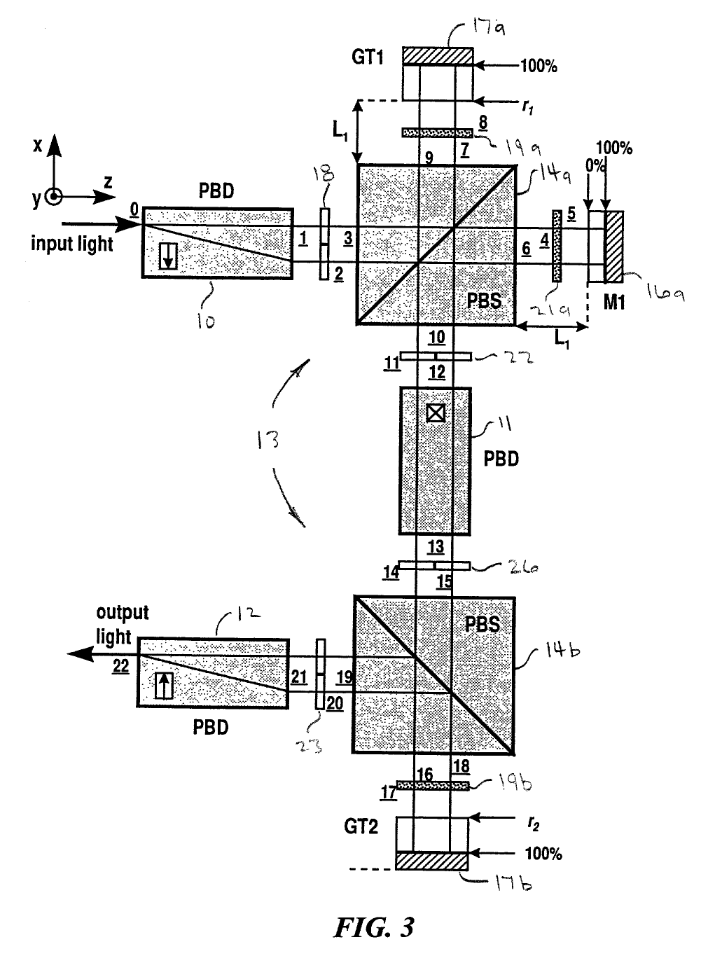

Like components of the drawings have like numbers. When more than one stage is shown, the like components in the different stages have the same number with different letters following the number. For example, the polarization beam splitter of the first stage shown in FIG. 3 is numbered 14a and the polarization beam splitter in the second stage of FIG. 3 is numbered 14b.

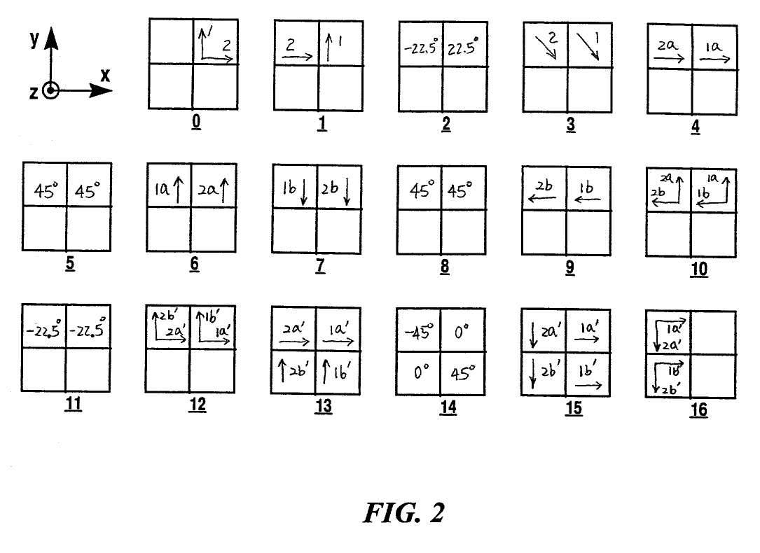

Referring now to FIG. 2, the optical beam states, the quarter-wave and half-wave waveplate orientations at various locations for the interleaver of FIG. 1 are shown. Each of the four boxes corresponds to the physical beam position at various locations. The polarization beam displacers shift the optical beams to these beam positions according to the orientation of the polarization beam displacers, the optical beam polarization direction, and optical beam propogation direction.

At location 0, a non-polarized input optical beam has two linearly polarized components 1 (along the y-axis) and 2 (along the x-axis) at the top-right beam position. After the beam propagates through the input polarization beam displacer 10 to location 1, light component 2 shifts to the top-left beam position and component 1 remains at the top-right beam position. The arrows shown on the polarization beam displacers indicate the beam shift direction. After components 1 and 2, respectively, pass through two half-wave waveplates at location 2, the linearly polarized components 1 and 2 are polarized along the same direction, i.e., −45° with respect to the +x axis at location 3. In order to make this happen, the optic axis of the half-wave waveplate (at location 2) for component 1 is oriented at 22.50 with respect to the +x axis at that location and the optic axis of the half-wave waveplate for component 2 is oriented at −22.5° with respect to the +x axis at that location.

When component 1 enters the polarization beam splitter 14a, it splits into two subcomponents of equal amplitude 11a and 11b. The subcomponent polarizes in the x-direction (1a), propagates along its original propagation direction to location 4. At location 5, the quarter-wave waveplate is oriented at 45° with respect to the +x axis at that location. After component 1apasses through the quarter-wave waveplate 21a, it is reflected by GT resonator 16a and passes back through quarter-wave waveplate 21a. Its polarization direction is changed from the x-axis direction to the y-axis direction at location 6.

On the other hand, the subcomponent polarized in the y-direction (1b) is deflected by the polarization beam splitter 14a and propagates in a direction generally orthogonal to the input beam propagation direction to location 7. The quarter-wave waveplate (19a) at location 8 is oriented at 45° with respect to the +x axis at that location. The polarization direction of components 1b is changed from the y-direction to the x-direction when it comes back to location 9, after being reflected by GT resonator 17a and passing through quarter-wave waveplate 19a one more time.

The Gires-Tournois or GT resonator is an asymmetric Fabry-Perot resonator with a partially reflecting front interface and a fully reflecting (100%) back interface. The reflection coefficient of the partially reflecting front interface of the GT resonator 17a is designated as r₁. The optical path length between the partially reflecting front interface and the full backreflecting interface is designated as nl₁ for the Gires-Tournois resonator 17a, where n is the refractive index and 1₁ is the thickness of the medium in the GT resonator. For a single optical medium, the optical path length nl is defined as the product of the refractive index n and the physical path length l.

As shown in FIG. 1, GT resonator 16a is a special GT resonator having a non-reflecting front interface (r=0%). For GT 16a the optical path length between the non-reflecting interface (r=0%) and the full backreflecting interface is nl₁/2. The nl₁ value determines the channel wavelengths of the interleaver.

As discussed above and shown in FIG. 1, the optical input component 1 is split into two subcomponents, 1a and 1b, of equal amplitude by the polarization beam splitter 14a. The optical path length between the beam split point and the non-reflecting interface of GT resonator 16a for component 1a is the same as that between the beam split point and the partially reflecting interface of GT resonator 17a for component 1b. After being reflected by GT resonator 16a and GT resonator 17a, respectively, components 1a and 1b are combined at location 10. A similar description is applied for the propagation of component 2 (2a and 2b). Components 1 and 2 pass through another half-wave waveplate 22 at location 11 which is oriented at −22.5°. This changes the polarization direction of subcomponents 1a, 1b, 2a, and 2b before they enter the intermediate polarization beam displacer. The new x and y components are shown at location 12 and the corresponding optical amplitude for these components can be written as:

$$\begin{matrix}along x \text{-} direction : {A}_{{ka}^{′}} = \frac{1}{2} ( \frac{{r}_{1} + {e}^{i {Γ}_{1}}}{1 + {r}_{1} {e}^{i {Γ}_{1}}} + {e}^{i {Γ}_{1} / 2} ) {A}_{k} & ( k = 1 , 2 ) \\ along y \text{-} direction : {A}_{{kb}^{′}} = \frac{1}{2} ( \frac{{r}_{1} + {e}^{i {Γ}_{1}}}{1 + {r}_{1} {e}^{i {Γ}_{1}}} + {e}^{i {Γ}_{1} / 2} ) {A}_{k} & ( k = 1 , 2 )\end{matrix}$$

along x-direction:

along y-direction:

where Ak (k=1,2) are the optical field amplitude of components 1 and 2, respectively, at input (location 0), the phase delay Γ₁=4πnl₁ cosθ₁/λ=4πnl₁/λ (θ₁=0° for normal incidence) determines the interleaver channel wavelengths, and λ is the optical wavelength.

After the optical beams pass through the intermediate polarization beam displacer 11, the light components polarized along the y-direction move to the bottom beam locations and the light components polarized along the x-direction remain at their corresponding top beam positions at location 13. Half-wave waveplates 23 are used at location 14 with their corresponding orientations as shown in FIG. 2. After the optical beams have passed through the waveplates, their polarization directions are as shown in FIG. 2 for location 15. After they pass through the output polarization beam displacer 12, component 1a′ moves to the top-left beam position to combine with component 2a′ and component 1b′ moves to the bottom-left beam position to combine with component 2b′ at location 16.

Because the beam shift is symmetric in the apparatus, the polarization mode dispersion (PMD) is minimized. The output optical beams at the top-left beam position and the bottom-left beam position correspond to the odd channels and the even channels, respectively, of the interleaver.

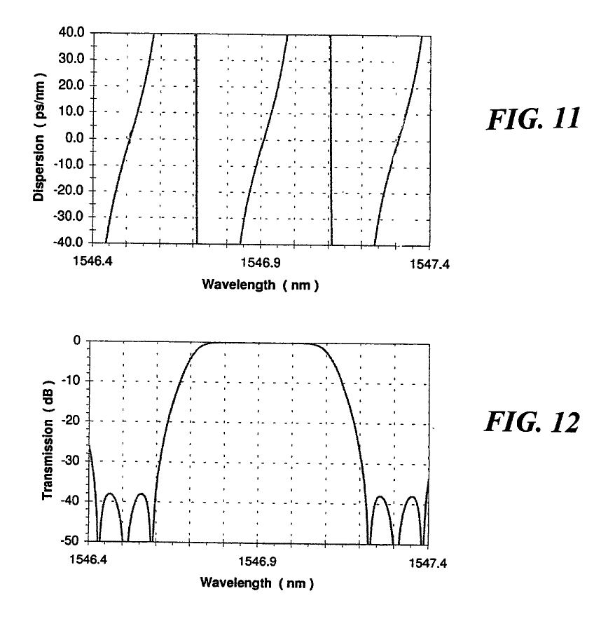

Referring now to FIGS. 11 and 12, the transmission and dispersion, both as a function of wavelength, for one channel in the two sets of interleaved channels, e.g., the odd channels, in a 50 GHz interleaver with r₁=0.38 where the 50 GHz channel spacing is determined by Γ₁. As shown in FIG. 12, a wide flat passband is obtained and crosstalk is nearly −40 dB for the stopband.

As shown in FIG. 11, the dispersion increases very rapidly as the wavelength moves away from the center wavelength of the passband. Actual channel wavelength cannot always be well controlled at the passband center due to various limitations in devices and optical systems. It is clear that channel wavelength deviation can lead to significant dispersion and thus undesirably degrade signal quality.

Referring now to FIG. 3, a two-stage interleaver, utilizing three Gires-Tournois resonators, 16a, 17a and 17b, provides improved dispersion characteristics with respect to the single-stage interleaver of FIG. 1 according to another embodiment of current invention.

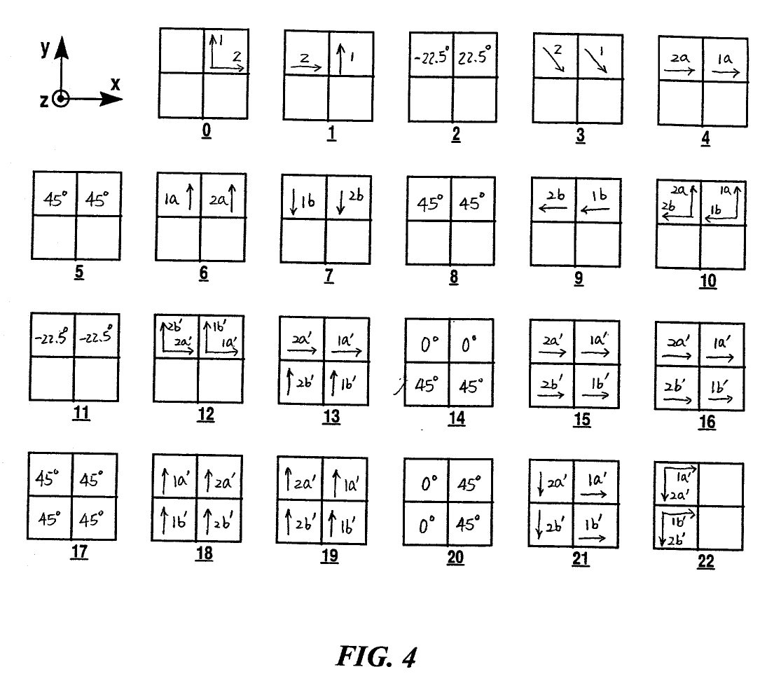

Referring now to FIG. 4, the optical beam states and the quarter-wave and half-wave waveplates orientations at various locations for the interleaver in FIG. 3 are shown. After the optical beams pass through the intermediate polarization beam displacer 11, the light components polarized along the y-direction move to the bottom beam locations and the light components polarized along the x-direction remain at their corresponding top-beam positions as shown for location 13. Half-wave waveplates 26 are used at location 14 with their corresponding orientations as shown in FIG. 4. After the optical beams pass through these waveplates, their polarization directions are all parallel with respect to each other, along the x-direction as shown at location 15 in FIG. 4.

When the optical beams enter the intermediate polarization beam splitter 11, they propagate along their original propagation direction to location 16. At location 17, quarter-wave waveplate 19b is oriented at 45° with respect to the +x axis at that location. After the optical beams pass through the quarter-wave waveplate 19b, they are reflected by a third GT resonator 17b and pass through the quarter-wave waveplate 19b again. Their polarization directions are changed from along the x-direction to along the y-direction at location 18. When the optical beams enter the second polarization beam splitter 14b from location 18, they are deflected by the second polarization beam splitter 14b by 90 degrees and propagate to location 19. Half-wave waveplates 23 are used at location 20 with their corresponding orientations as shown in FIG. 4. After the optical beams pass through half-wave waveplates 23, their polarization directions are as shown at location 21 in FIG. 4. After they pass through the output polarization beam displacer 12, component 1a′ moves to the top-left beam position to combine with component 2a′ and component 1b′ moves to the bottom-left beam position to combine with component 2b′ at location 22.

Because the beam shift is symmetric in the apparatus, the polarization mode dispersion (PMD) is minimized. The output optical beams at the top-left beam position and the bottom-left beam position correspond to the odd channels and the even channels, respectively, of the interleaver.

The reflection coefficient of the partially reflecting interface of the third GT resonator 17b is designated as r₂ as shown in FIG. 3. The phase delay caused by the second Gires-Tournois resonator 17b is Γ₂=4π nl₂ cosθ₂/λ=4πnl₂/λ (θ₂=0° for normal incidence). The Γ₂ value is very close to the value of the phase delay Γ₁ caused by the second GT resonator 17a. Thus, the phase delay Γ₂ value may be either slightly larger or slightly smaller than the phase delay Γ₁ value. Control of the Γ₂ value can be realized by either fine tuning the optical path length nl₂ or by fine tuning the incidence angle θ₂. The purpose of the third GT resonator 17b is to introduce additional phase modification to the optical beam so as to improve the dispersion characteristics of interleaver while keeping the superior passband and stopband characteristics unchanged.

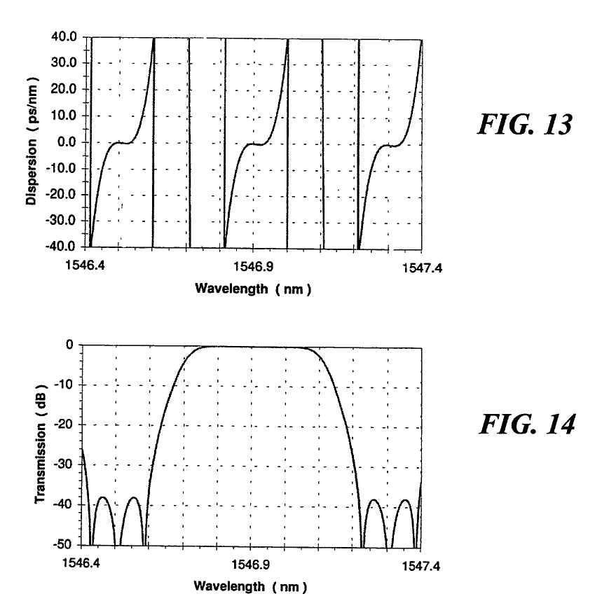

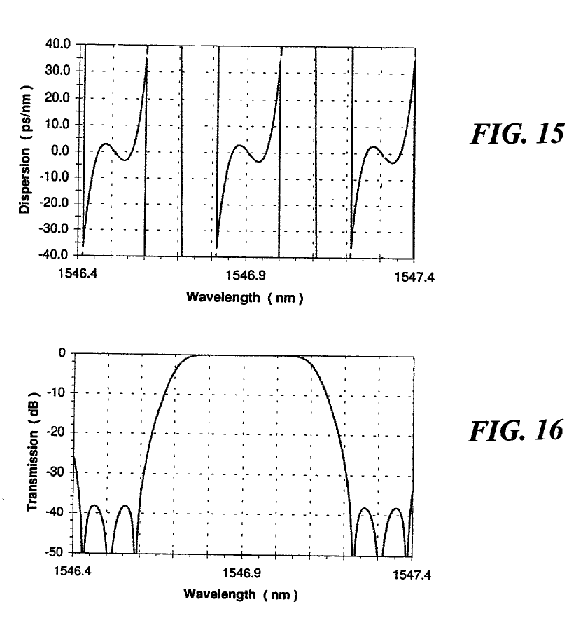

Referring now to FIGS. 13 and 14, the transmission and dispersion versus wavelength for one channel in the two sets of interleaved channels, e.g., the odd channels, in a 50 GHz two-stage interleaver having r₁=0.38, r₂=0.04 and Γ₂ /Γ₁=1.0001285, where the 50 channel spacing is determined by Γ₁. As shown in FIG. 13, the dispersion characteristic is substantially improved with respect to the dispersion characteristic shown in FIG. 11 for a single-stage Gires-Tournois interleaver. Indeed, the dispersion shown in FIG. 13 is almost zero in the wavelength range of approximately 0.1 nm near the passband center wavelength. If the system requirement for dispersion is less than 5 ps/nm, a wavelength range of about 0.3 nm can be obtained to satisfy this requirement by changing r₂ to 0.05, wherein the corresponding transmission and dispersion characteristics are shown in FIGS. 15 and 16.

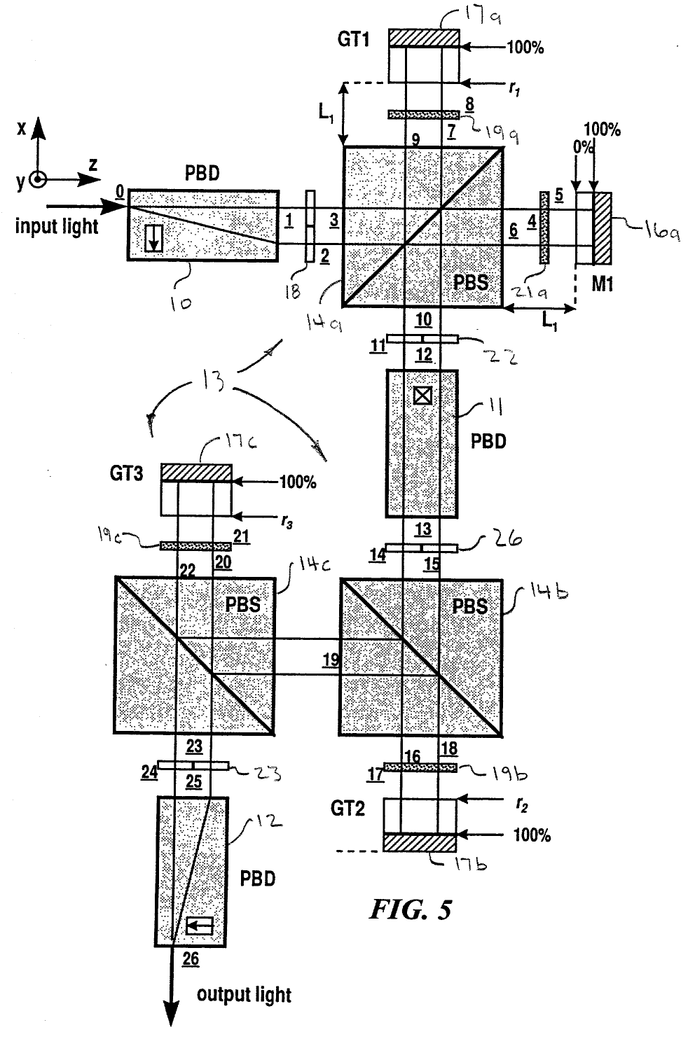

Referring now to FIG. 5, the dispersion characteristics can be further improved by utilizing three-stage and four Gires-Tournois resonators in the interleaver.

The device shown in FIG. 5 is particularly worthy of additional discussion because it illustrates the use of a dispersion mitigation portion having multiple stages of dispersion mitigation in combination with an interleaver portion. The interleaver portion comprises the polarization beam splitter 14a, the mirror or the first Gires-Tournois resonator 16a and the second Gires-Tournois resonator 17a, along with half-wave waveplate 18 and quarter-wave waveplates 19a and 21 a.

The polarization beam displacer 10 is only necessary when a composite beam having an unknown or uncontrolled polarization component is provided as the light input. As those skilled in the art will appreciate, when input light is provided having a controlled or known polarization direction, then the polarization beam displacer can may be omitted. The polarization beam displacer 10 separates a composite beam of input light having unknown polarization components into two separate light beams, wherein each of the two separate light beams have known polarization directions.

The interleaver portion of the device shown in FIG. 5 separates the light beam input thereto into two sets of channels (odd and even), wherein each set of channels has a wider spacing than that of the input beam. However, as those skilled in the art will further appreciate, the output of the interleaver portion of this device tends to have undesirably high dispersion, thus limiting its use to those applications where such dispersion can be tolerated, i.e., for communications over comparatively short distances.

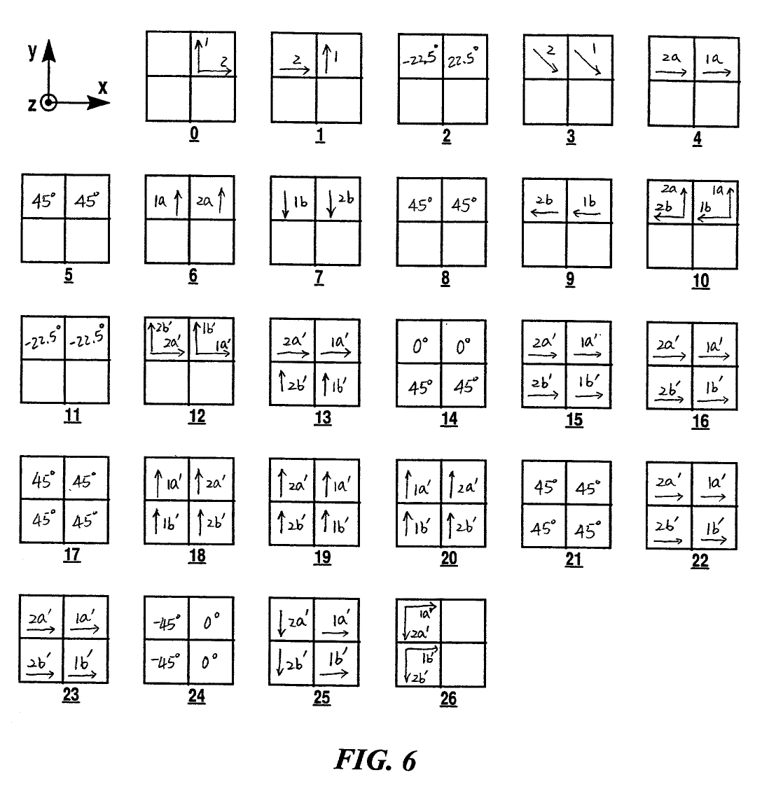

The polarization beam displacer 11 merely displaces the vertical components 2b′ and 1b′ (as shown in FIG. 6) of the light input thereto downwardly, in preparation for the dispersion mitigating stages to follow.

As shown in FIG. 5, two dispersion mitigating stages are provided, so as to substantially mitigate dispersion from the interleaver portion of the device, and thereby render the device more suitable for use in communications over longer distances. Each stage of dispersion mitigation comprises a polarization beam splitter 14b and 14c and a Gires-Tournois resonator 17b and 17c. Half-wave waveplate 23 and quarter-wave waveplates 19b and 19c are used to orient light passing through the polarization beam splitters 14b and 14c as necessary so as to cause the light to travel in the desired directions and with the desire amplitudes, as shown in FIG. 6. As those skilled in the art will appreciate, each additional stage of dispersion mitigation further enhances a dispersion characteristics of the interleaver.

An output portion of the device comprises polarization beam displacer 12 which combines the four component output of the final stage of dispersion mitigation into two components, wherein each component defines a different set of channels (odd and even channels, respectively) of the interleaver.

Referring now to FIG. 6, the optical beam states and quarter-wave and half-wave waveplate orientations at various locations for the three-stage interleaver of FIG. 5 are shown. The reflection coefficient of the partially reflecting interface of the fourth Gires-Tournois resonator 17c is designated as r₃. The phase delay caused by the third Gires-Tournois resonator 17c is Γ₃=4πnl₃ cosθ₃/λ=4π nl₃/λ (θ₃=0° for normal incidence). Similar to the third Gires-Tournois resonator in 17b, the fourth Gires-Tournois resonator 17c has a Γ₃ value which is very close to the Γ₁ value and thus is either slightly larger or smaller than the Γ₁. The control of the Γ₃ can be realized by either fine tuning the optical path length nl₃ or by fine tuning the incidence angle θ₃. Similarly, at location 26 the output optical beams at the top-left beam position and the bottom-left beam position correspond to the odd channels and the even channels, respectively, of the interleaver.

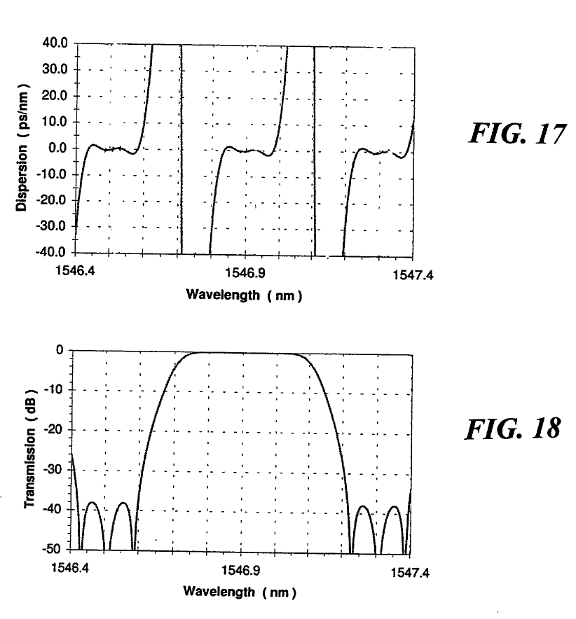

Referring now to FIGS. 17 and 18, the transmission and dispersion versus wavelength charts are shown for one channel of the two sets of interleaved channels, e.g. the odd channels, in a 50 GHz three-stage interleaver having r₁=0.38, r₂=0.09, r₃=0.09, Γ₂/Γ₁=1.0001720 and Γ₃/Γ₁=1.0000853, where the 50 GHz channels spacing is determined by Γ₁. As shown in FIG. 17, a wavelength range of greater 0.3 nm can be obtained for a dispersion of less than 2 ps/nm.

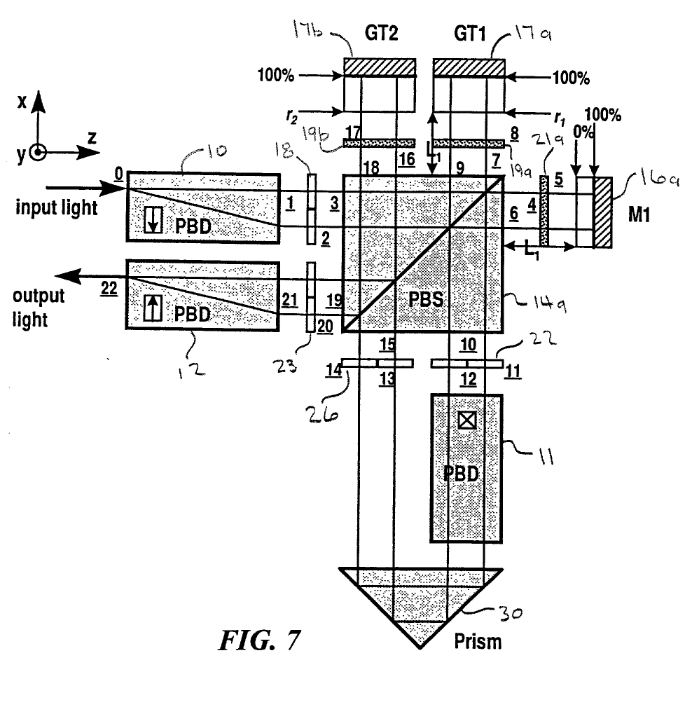

Referring now to FIG. 7, a two-stage interleaver may alternatively be configured so as to utilize three Gires-Tournois resonators, 16a, 17a and 17b, where a right-angle prism is employed and only a single polarization beam splitter 14a is used.

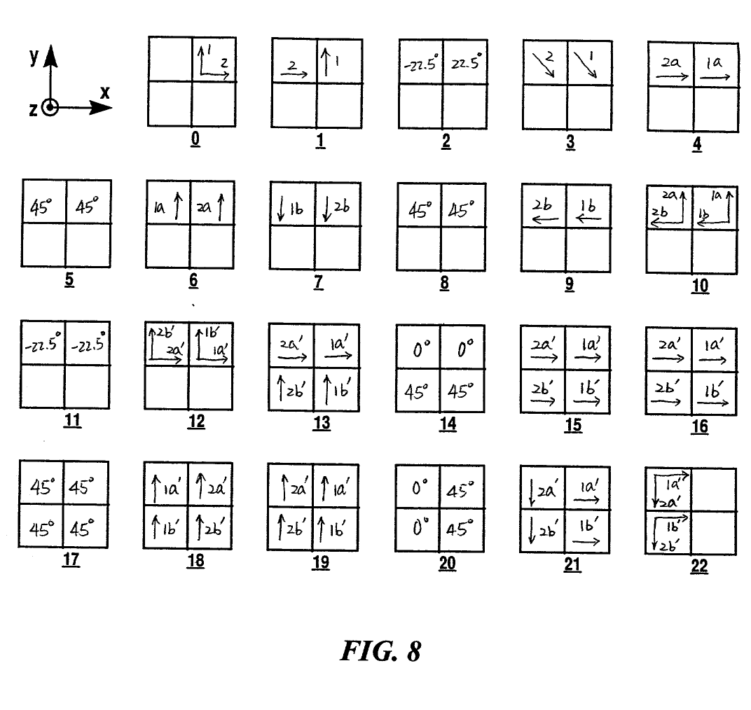

Referring now to FIG. 8, the corresponding optical beam states and quarter-wave and half-wave waveplates orientations at various locations of the two-stage interleaver of FIG. 7 are shown.

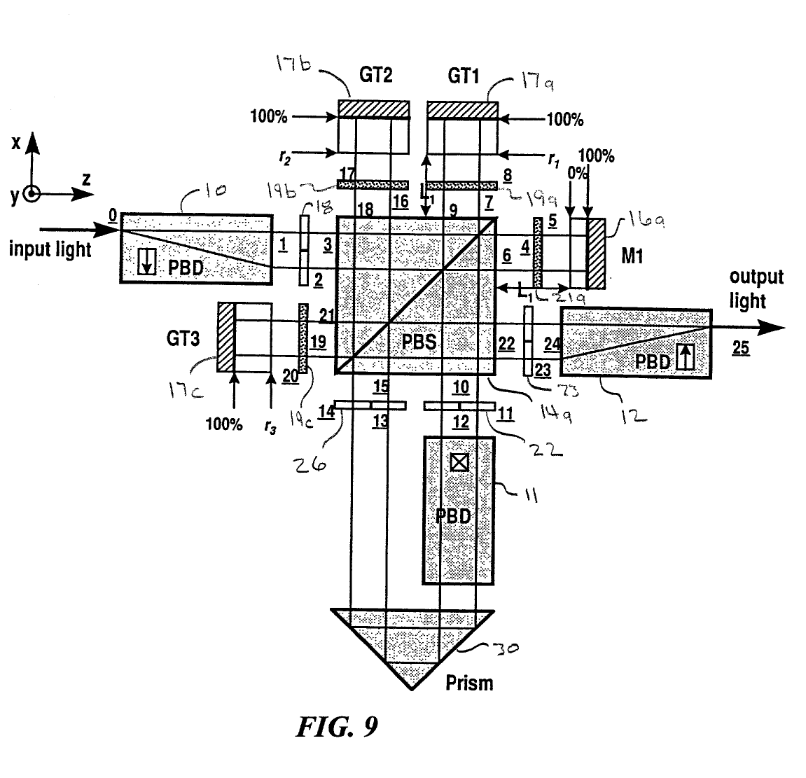

Referring now to FIG. 9, a three-stage interleaver may be similarly configured to utilize four Gires-Tournois resonators, 16a, 17a, 17b and 17c, wherein a right-angle prism is employed and only a single polarization beam splitter 14a is used.

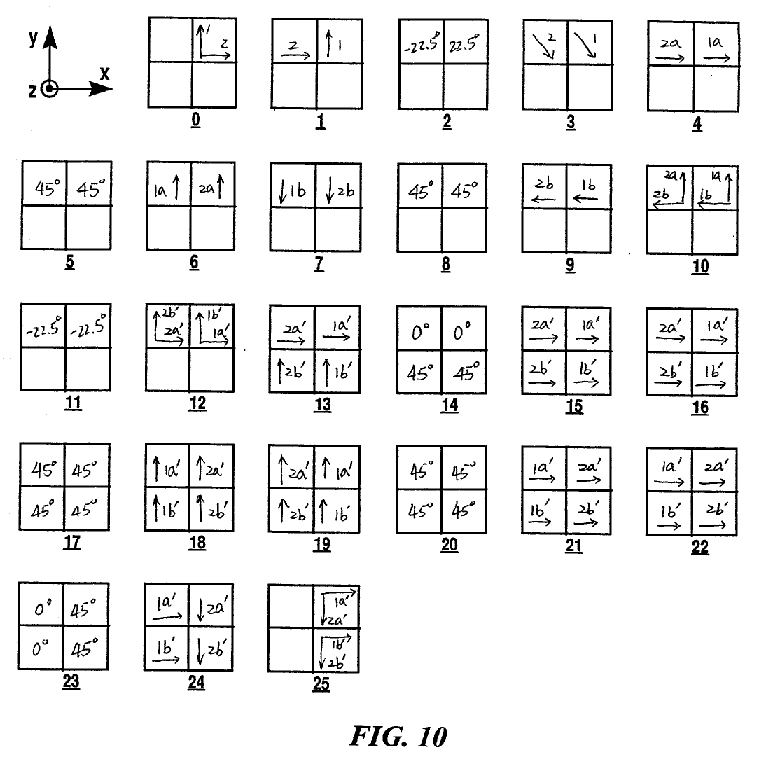

Referring now to FIG. 10, the optical beam states and the quarter-wave and half-wave waveplate orientations at various locations in the three-stage interleaver of FIG. 9 are shown.

As those skilled in the art will appreciate, such use of a prism (as shown in FIGS. 7 and 9) reduces the number of polarization beam splitters required and thus reduces the cost of the device. Another advantage of the interleavers configuration of FIGS. 7 and 9 is the compact size thereof. Reducing the number of polarization beam splitter substantially reduces the size of the interleaver.

However, the polarization beam splitters of FIGS. 7 and 9 may optionally be replaced with two separate polarization beam splitters.

Although specific examples of orientations for the waveplates described herein are given and specific values for the reflection coefficients and the phase delays of the GT resonators are given, those skilled in the art will appreciate the various other waveplate orientations and reflection coefficient and phase delays for GT resonators can likewise be used. Further, the use of a 50 GHz interleaver by way of example only and not by way of limitation. Those skilled in the art will appreciate that various other channels spacing, particularly smaller or larger channel spacings, may likewise be utilized.

An ultra low expansion (ULE) or fused silica may be utilized as a gasket in device construction, so as to obtain excellent temperature stability for the interleaver. Those skilled in the art will appreciate the various other materials having a very low thermal expansion coefficient are likewise suitable for use as such a gasket.

The interleavers described herein are suitable for demultiplexing optical signals. Those skilled in the art will appreciate similar structures may be utilized to multiplex optical signals.

As those skilled in the art will appreciate, the waveplates which are utilized in the present invention can be replaced by other devices. Various devices and/or materials may alternatively be utilized to orient the polarization direction of light beams. For example, devices and/or materials which are responsive to applied voltages, currents, magnetic fields and/or electrical fields may be used to orient the polarization direction of light beams. Thus, the use of waveplates herein is by way of example only, and not by way of limitations.

Further, when waveplates (either half-wave waveplates or quarter-wave waveplates) having identical orientations are dispose next to one another, then a common waveplate may be substituted therefor.

As used herein, the term gasket is defined to include any bracket, mount, optical bench, host, enclosure or any other structure which is used to maintain components of the present invention in desired positions relative to one another. Preferably, such gasket is comprised of an ultra low expansion (ULE) material, fused silica or any other material having a very low thermal expansion coefficient.

It is important to appreciate that the space, L₁, between each Gires-Tournois resonator and the polarization beam splitter of the interleaver stage, as well as, the space between each Gires-Tournois resonator and each polarization beam splitter of each dispersion mitigating stage may comprise any desired light transmissive material, such as air, vacuum, a transparent fluid, or any other desired transparent material. Further, this space may be substantially eliminated by disposing each Gires-Tournois resonator immediately proximate a waveplate and by disposing the waveplate immediately proximate the polarization beam splitter.

It is also important to appreciate that, in many instances, a single polarization beam splitter can be replaced with plurality of polarization beam splitters, wherein each individual polarization beam splitter of the plurality accommodates a particular light path. For example, in FIG. 1, two light paths are shown coming from polarization beam displacer 10 and traveling through polarization beam splitter 14a. Thus, polarization beam splitter 14a may, if desired, be replaced with two separate polarization beam splitters, wherein each separate polarization beam splitter accommodates one of the two paths.

It is also important to appreciate that various different light transmissive media may be utilized to obtain the desired phase delay between the two light paths of the interleaver defined by the polarization beam splitter (such as 14a of FIG. 1) and the two reflectors (such as 16a and 17a of FIG. 1). It is desirable that the phase delay provided by the second reflector 17a be approximately twice that of the phase delay provided by the first reflector 16a. Those skilled in the art will appreciate that this phase delay may be provided by variations in the light paths, such as the variations in physical length and the index of refraction of materials placed within the lights path, or any combined variations of physical length and index of refraction. Indeed, various different combinations of light transmissive materials may be utilized so as to provide the desired phase delay. It is generally desirable that any materials and/or distances which contribute to such differences in phase delay be thermally stable, such that the phase delay does not vary substantially with temperature changes.

The first GT resonator 16a is a special GT resonator wherein the front reflection coefficient is r=0% and can be simply replaced by a mirror, as long as the position of the mirror is adjusted so that the subcomponent in this path will have an effective phase deley of Γ₁/2.

It is important to appreciate that for the interleavers described above, the values utilized for r₁, r₂, r₃, Γ₂/Γ₁ and Γ₃/Γ₁ are exemplary only. Thus, such values are by way of illustration only and not by way of limitation. Those skilled in the art will appreciate that other values for these parameters are likewise suitable. For example, values of Γ₂/Γ₁ and/or Γ₃/Γ₁ which are slightly less than 1 are similarly suitable. In addition, one can utilize more than four Gires-Tournois resonators to construct interleavers of stages more than three-based upon the spirit of this invention. Indeed, those skilled in the art will appreciate, any desired number of Gires-Tournois resonators may be so utilized. It is understood that the exemplary interleaver described herein and shown in the drawing represents only presently preferred embodiments of the invention. Indeed various such modifications and additions can be made to the embodiments without departing from the sphere and scope of the invention. Those skilled in the art will appreciate that various modifications and additions may be obvious to those skilled in the art and may be implemented to adapt the present invention for use in various different applications.

1. An interleaver comprising:
a beam separator/recombiner configured to separate at least one component beam into first and second approximately equal amplitude subcomponents thereof, each component beam having a defined polarization direction, the beam separator/recombiner also being configured to subsequently recombine the separated first and second subcomponents back into components;
a first reflector configured to direct the first subcomponent from the beam separator/recombiner back into the beam separator/recombiner; and
a second reflector configured to direct the second subcomponent from the beam separator/recombiner back into the beam separator/recombiner.

2. The interleaver as recited in claim 1, further comprising an input beam separator configured to separate an input beam into two component beams in a manner which defines a polarization direction of each component beam.

3. The interleaver as recited in claim 1, further comprising an input beam separator configured to separate an input beam into two component beams in a manner which defines a polarization direction of each component beam, the input beam separator comprising a polarization beam separator.

4. The interleaver as recited in claim 1, wherein the beam separator/recombiner is configured to separate two component beams, each component beam being separated into first and second approximately equal amplitude subcomponents thereof.

5. The interleaver as recited in claim 1, wherein the beam separater/recombiner comprises at least one polarization beam splitter.

6. The interleaver as recited in claim 1, wherein the first reflector comprises a Gires-Tournois reflective resonator.

7. The interleaver as recited in claim 1, wherein the second reflector comprises a Gires-Tournois reflective resonator.

8. The interleaver as recited in claim 1, wherein:
the first reflector comprises a Gires-Tournois reflective resonator having a front surface reflectivity of approximately zero and having a rear surface reflectivity of approximately 100%;
the second reflector comprises a Gires-Tournois reflective resonator having a front surface reflectivity of greater than zero and having a rear surface reflectivity of approximately 100%; and
the first reflector provides a phase delay of approximately one half of the phase delay provided by the second reflector.

9. The interleaver as recited in claim 1, further comprising:
a half-wave waveplate configured to orient each component beam such that the beam separator/combiner separates each component beam into two subcomponent beams having approximately equal amplitude; and
a quarter-wave waveplate configured to orient each subcomponent beam such that the subcomponent beams recombine in the beam separator/recombiner and such that the subcomponent beams do not interfer substantially with the component beam(s) prior to the component beam(s) being separated by the separator/recombiner.

10. The interleaver as recited in claim 1, further comprising:
an intermediate beam separator configured to separate each component beam from the beam separator/recombiner into two subcomponent beams, the intermediate beam separator comprising a half-wave waveplate and a polarization beam displacer.

11. The interleaver as recited in claim 1, further comprising:
an output beam recombiner configured to combine subcomponent beams into component beams, the output beam recombiner comprising a half-wave waveplate and a polarization beam displacer.

12. The interleaver as recited in claim 1, further comprising at least one dispersion mitigating stage, each dispersion mitigating stage comprising:
a dispersion mitigating Gire-Tournois resonator; and
a polarization beam splitter configured to transmit light to a dispersion mitigating Gires-Tournois resonator and configured to reflect light from the dispersion mitigating Gires-Tournois resonator away from light input to the polarization beam splitter such that the light reflected away from light input to the polarization beam splitter does not interfere with the light input to the polarization beam splitter.

13. The interleaver as recited in claim 1, further comprising at least one dispersion mitigation stage, each dispersion mitigating stage comprising:
a dispersion mitigating Gire-Tournois resonator;
a polarization beam splitter configured to transmit light to a dispersion mitigating Gires-Tournois resonator and configured to reflect light from the dispersion mitigating Gires-Tournois resonator away from light input to the polarization beam splitter such that the light reflected away from light input to the polarization beam splitter does not interfere with light input to the polarization beam splitter; and
a half-wave waveplate and a quarter-wave waveplate configured to orient light when the light passes through the dispersion mitigating stage of the Gires-Tournois resonator such that the light does not interfere with light input to the polarization beam splitter.

14. The interleaver as recited in claim 1, further comprising at least one dispersion mitigation stage, each dispersion mitigating stage comprising:
a dispersion mitigating Gire-Tournois resonator;
a polarization beam splitter configured to transmit light to a dispersion mitigating Gires-Tournois resonator and configured to reflect light from the dispersion mitigating Gires-Tournois resonator away from light input to the polarization beam splitter such that the light reflected away from light input to the polarization beam splitter does not interfere with light input to the polarization beam splitter;
a quarter-wave waveplate configured to orient light reflected from each dispersion mitigating Gires-Tournois resonator such that the light does not interfere with light input to the polarization beam splitter; and
a half-wave waveplate and an output polarization beam displacer for combining subcomponent beams from last dispersion mitigation stage into odd and even channel components.

15. A method for interleaving, the method comprising:
separating at least one component beam into first and second approximately equal amplitude subcomponents thereof, each component beam having a defined polarization direction;
directing the first subcomponent from a beam separator/recombiner back into the beam separator/recombiner;
directing the second subcomponent from the beam separator/recombiner back into the beam separator/recombiner; and
recombining the separated first and second subcomponents back into components.

16. The method as recited in claim 15, further comprising separating an input beam into two component beams in a manner which defines a polarization direction of each component beam.

17. The method as recited in claim 15, wherein separating at least one component beam comprises separating at least one component beam using at least one polarization beam splitter.

18. The method as recited in claim 15, wherein:
directing the first subcomponent compromises directing the first subcomponent using a first Gires-Tournois reflective resonator; and
directing the second subcomponent comprises directing the second subcomponent using a Gires-Tournois reflective resonator.

19. The method as recited in claim 18, wherein:
the first Gires-Tournois reflective resonator has a front surface reflectivity of approximately zero and has a rear surface reflectivity of approximately 100%;
the second reflector comprises a Gires-Tournois reflective resonator has a front surface reflectivity of greater than zero and having a rear surface reflectivity of approximately 100; and
the first Gires-Tournois reflector provides a phase delay of approximately one half of the phase delay provided by the second Gires-Tournois reflector.

20. A device for mitigating dispersion, the device comprising:
a Gires-Tournois resonator; and
a polarization selection element configured to direct light to the Gires-Tournois resonator and configured to reflect light from the Gires-Tournois resonator away from light input to the polarization selection element.

21. The device as recited in claim 20, wherein:
the polarization selection element comprises a polarization beam splitter; and
a quarter-wave waveplate configured to cause the polarization beam splitter to reflect light away from the light input to the polarization beam splitter.

22. An interleaver comprising:
a first beam separator/recombiner configured to separate at least one component beam into first and second approximately equal amplitude subcomponents thereof, each component beam having a defined polarization direction, the first beam separator/recombiner also being configured to subsequently recombine the separated first and second subcomponents back into components;
a first reflector configured to direct the first subcomponent from the first beam separator/recombiner back into the first beam separator/recombiner;
a second reflector configured to direct the second subcomponent from the first beam separator/recombiner back into the first beam separator/recombiner;
a second beam separator/recombiner;
a third reflector configured to direct recombined first and second subcomponents from the first beam separator/recombiner to the second beam separator/recombiner;
a fourth reflector configured to direct light from the second beam separator/recombiner back into the second beam separator/recombiner; and
wherein the second beam separator/recombiner is configured to transmit light from the third reflector to the fourth reflector and to reflect light from the fourth reflector out of the second separator/recombiner.

23. The interleaver as recited in claim 22, wherein the first beam separator/recombiner and the second beam separator/recombiner comprise a common polarization beam splitter.

24. The interleaver as recited in claim 22, wherein the first beam separator/recombiner and the second beam separator/recombiner comprise two separate polarization beam splitters.

25. The interleaver as recited in claim 22, wherein:
the first reflector comprises a Gires-Tournois resonator;
the second reflector comprises a Gires-Tournois resonator;
the third reflector comprises a prism; and
the fourth reflector comprises a Gires-Tournois resonator.

26. The interleaver as recited in claim 22, further comprising a fifth reflector configured to reflect light from the second beam separator/recombiner back through the second beam separator/recombiner.

27. The interleaver as recited in claim 26, wherein the fifth reflector comprises a Gires-Tornois resonator.
